(19) United States
(12) Patent Application Publication
(10) Pub. No.: US 2014/0133774 A1
(43) Pub. Date: May 15, 2014

(54) IMAGE PROCESSOR AND IMAGE DEAD PIXEL DETECTION METHOD THEREOF

(71) Applicant: INDUSTRIAL TECHNOLOGY RESEARCH INSTITUTE, Hsinchu (TW)

(72) Inventor: Chien-Wei Chen, Hsinchu County (TW)

(73) Assignee: INDUSTRIAL TECHNOLOGY RESEARCH INSTITUTE, Hsinchu (TW)

(21) Appl. No.: 13/757,606

(22) Filed: Feb. 1, 2013

(30) Foreign Application Priority Data
Nov. 9, 2012 (TW) 101141893

(51) Int. Cl. G06K 9/40

(52) U.S. Cl. CPC G06K 9/40
USPC 382/263

(57) ABSTRACT

An image processor is capable of performing an image dead pixel detection method, so as to detect at least one dead pixel in an input image. The image dead pixel detection method includes the following steps. A high-pass filter processing is performed on an input image, so as to obtain a filter image. A global mean value and a global standard difference are obtained according to the filter image. A to-be-detected pixel in the filter image is selected. A local mean value, a local standard difference, and a global mean value difference and a local mean value difference are obtained according to the to-be-detected pixel and multiple neighboring pixels. When the global mean value difference and the global standard difference satisfy a first condition, and the local mean value difference and the local standard difference satisfy a second condition, the to-be-detected pixel is considered as a dead pixel.

### CROSS-REFERENCE TO RELATED APPLICATIONS

The present application is based on, and claims priority from, Taiwan Application Serial Number 101141893 filed Nov. 9, 2012, the entire contents of which are hereby incorporated by reference.

### TECHNICAL FIELD

The disclosure relates to an image processor and a detection method thereof, and more particularly, to an image processor and an image dead pixel detection method thereof.

### BACKGROUND

Along with the progress and development of technology, an image sensor, such as a Charge Coupled Device (CD) or a Complementary Metal-Oxide-Semiconductor (CMOS) has been widely adopted in various fields such as science, industry, national defense, aviation, commutation, and medicine. Since the adoptions of the image sensors in those fields heavily rely on digital images in driveway recognition, object tracking, or human face recognition, the quality of input image data dictates whether various applications employing the image sensors could perform as desired.

However, in fact, the image sensor is quite easy to generate noises. The image sensor may be associated with dead pixels because of the introduction of dust particles during the packaging process of the image sensor, and dead pixels caused by wear and tear of the image sensor. In addition, especially in the situation of a low light source or low-speed shutter, a higher light sensitivity results in more noises being generated. During photographing with long exposure, heat generated by the image sensor may lead to a black level, resulting in hot pixels on the part of the image sensor. Therefore, in many photography applications requiring long exposure, such as astronomical photography, severe noises could be usually present.

Currently, some advanced digital cameras have the long exposure noise reduction function for turning off the image sensor periodically to cool the image sensor, so as to remove the noise generated associated with the long exposure photographing. However, this approach prolongs the photographing time. In some cases such as astronomical photography, the photographing time with the aforementioned turning off the image sensor approach employed may be two times or even three times the original.

For determining whether a pixel is a dead pixel, another conventional approach by setting a preset threshold for identifying the correlation between neighboring pixels is also introduced. However, content in the input images varies significantly in different photographing scenarios. For example, if the same condition is used for the images photographed at day and at night significant errors are fully expected, leading to inaccurate detection of the dead pixels and therefore improper compensation. In the context of medical images, the improper compensation may misguide medical professionals to potentially fatal judgments.

### SUMMARY

According to one exemplary embodiment, an image dead pixel detection method is provided, a high-pass filter is performed on an input image to obtain a filter image; a global mean value and a global standard difference of the filter image are calculated; a to-be-detected pixel is selected from the filter image; a local mean value, a local standard difference, a global mean value difference and a local mean value difference are obtained according to the to-be-detected pixel and multiple neighboring pixels; and when the global mean value difference and the global standard difference corresponding to the to-be-detected pixel satisfy a first condition, and the local mean value difference and the local standard difference corresponding to the to-be-detected pixel satisfy a second condition, the to-be-detected pixel is considered as a dead pixel.

According to an alternative exemplary embodiment, an image processor is provided which has a filter module, a global calculation module, a local calculation module and a determination module, and is capable of executing the above image dead pixel detection method. The filter module is used for performing a high-pass filter processing on an input image to obtain a filter image. The global calculation module is used for calculating a global mean value and a global standard difference of the filter image. The local calculation module is used for selecting a to-be-detected pixel from the filter image, and obtaining a local mean value, a local standard difference, a global mean value difference and a local mean value difference according to the to-be-detected pixel and multiple neighboring pixels. The determination module is used for determining whether the global mean value difference and the global standard difference corresponding to the to-be-detected pixel satisfy a first condition, and whether the local mean value difference and the local standard difference corresponding to the to-be-detected pixel satisfy a second condition, before considering the to-be-detected pixel as a dead pixel.

### BRIEF DESCRIPTION OF THE DRAWINGS

The disclosure will become more fully understood from the detailed description given herein below for illustration only, and thus are not limitative of the disclosure, and wherein:

FIG. 1 is a schematic block diagram and image processor according to an embodiment of the disclosure;

FIG. 2 is a schematic flow chart of an image dead pixel detection method according to an embodiment of the disclosure;

FIG. 3 is a schematic view of normal distribution of distributed image content according to an embodiment of the disclosure;

FIG. 4 is a schematic view of a mask used by a Mexican hat filter Matrix according to an embodiment of the disclosure;

FIG. 5 is a schematic flow chart of step S100 according to an embodiment of the disclosure;

FIG. 6A is a schematic view of a dead pixel area according to an embodiment of the disclosure;

FIG. 6B is a schematic view of a normalized dead pixel area according to an embodiment of the disclosure;

FIG. 7A is a schematic view of probability density of dead pixels of an input image according to an embodiment of the disclosure;

FIG. 7B is a schematic view of probability density of dead pixels of a filter image according to an embodiment of the disclosure;

FIG. 8 is a schematic view of a local area according to an embodiment of the disclosure;

FIG. 9 is a schematic flow chart of step S130 according to an embodiment of the disclosure;

FIG. 10 is a schematic flow chart of step S130 according to an embodiment of the disclosure;

FIG. 11 is a schematic flow chart of step S132 according to an embodiment of the disclosure;

FIG. 12 is a schematic view of an input image according to an embodiment of the disclosure;

FIG. 13 is a schematic view of a buffer image according to an embodiment of the disclosure; and

FIG. 14 is a schematic view of a normalized filter image according to an embodiment of the disclosure.

### DETAILED DESCRIPTION

Detailed features and advantages of the disclosure are described in the embodiments below, and their content is adequate for those skilled in the art to understand the technical content of the disclosure and to implement the disclosure. According to the content disclosed in the specification, the claims, and the drawings, those skilled in the art can easily understand the objects and advantages of the disclosure.

The disclosure provides an image processor and an image dead pixel detection method thereof, so as to detect at least one dead pixel in an input image. In this embodiment and other embodiments, the dead pixel (also referred to as a dead point) is, for example, a hot pixel, a speckle noise, or a salt and pepper noise. In this embodiment and other embodiments, the dead pixel is a congenital dead pixel generated by an image sensor such as a Charge Coupled Device (CCD) or a Complementary Metal-Oxide-Semiconductor (CMOS) over the course of the manufacturing thereof, and it is also possible that the dead pixel is an aging dead pixel caused by wear and tear of the image sensor.

Moreover, in this embodiment and other embodiments, the dead pixel is also caused by the improper exposure of the image sensor because of a black level generated by heat associated with the long-time exposure in the photographing. In addition, visually, in this embodiment and other embodiments, stuck at high dead pixels or stuck at low dead pixels form noises of white points or black points on the image when the dead pixels also form noises on each color separation layer of a Bayer Pattern.

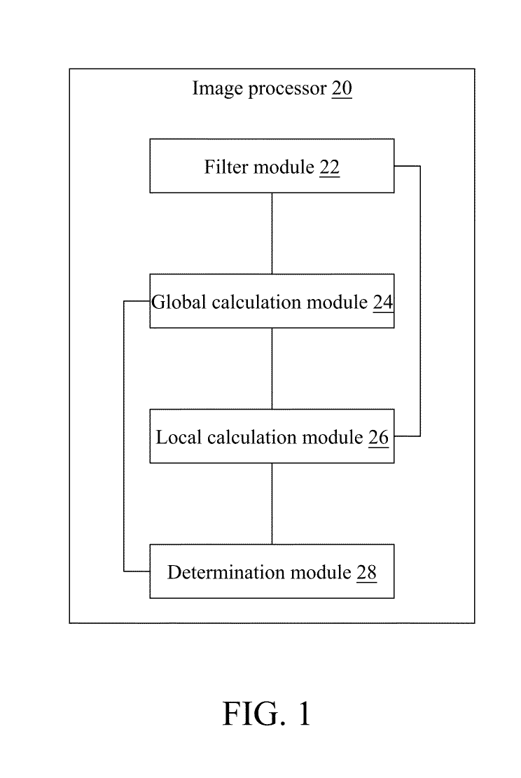

Referring to FIG. 1, a schematic block diagram of an image processor according to an embodiment of the disclosure is shown. An image processor 20 has a filter module 22, a global calculation module 24, a local calculation module 26 and a determination module 28, and is capable of executing the image dead pixel detection method.

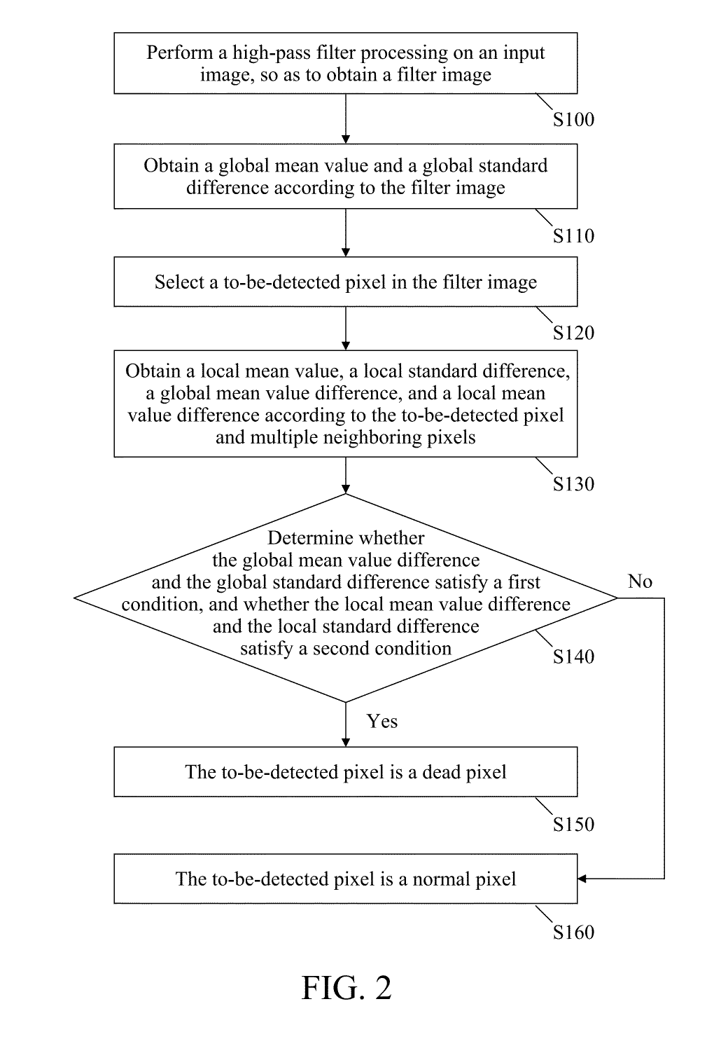

Referring to FIG. 2, a schematic flow chart of an image dead pixel detection method according to an embodiment of the disclosure is shown.

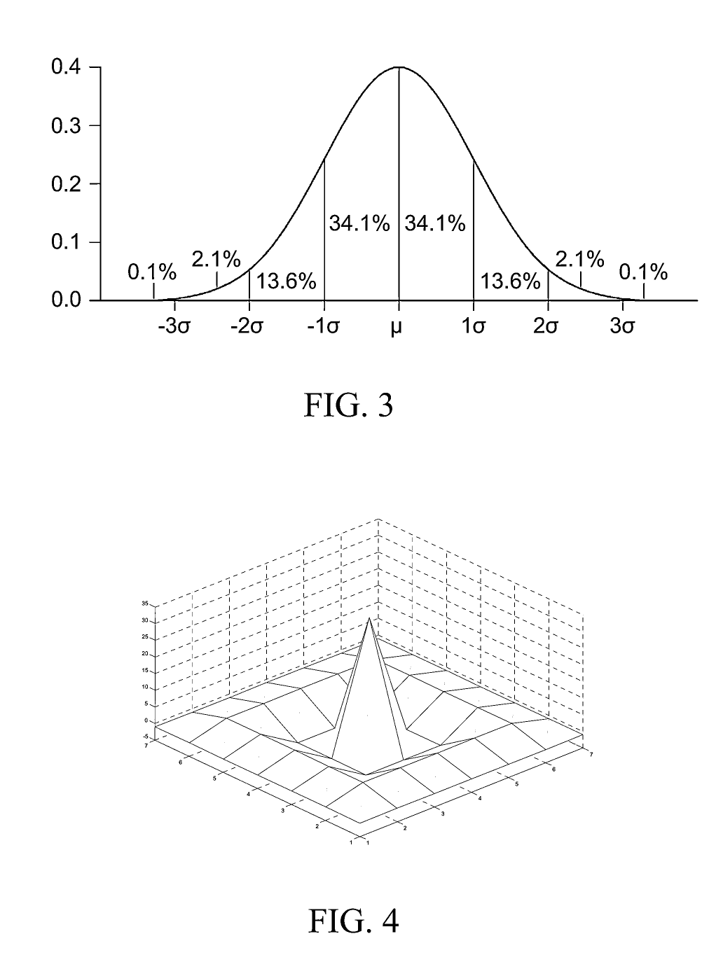

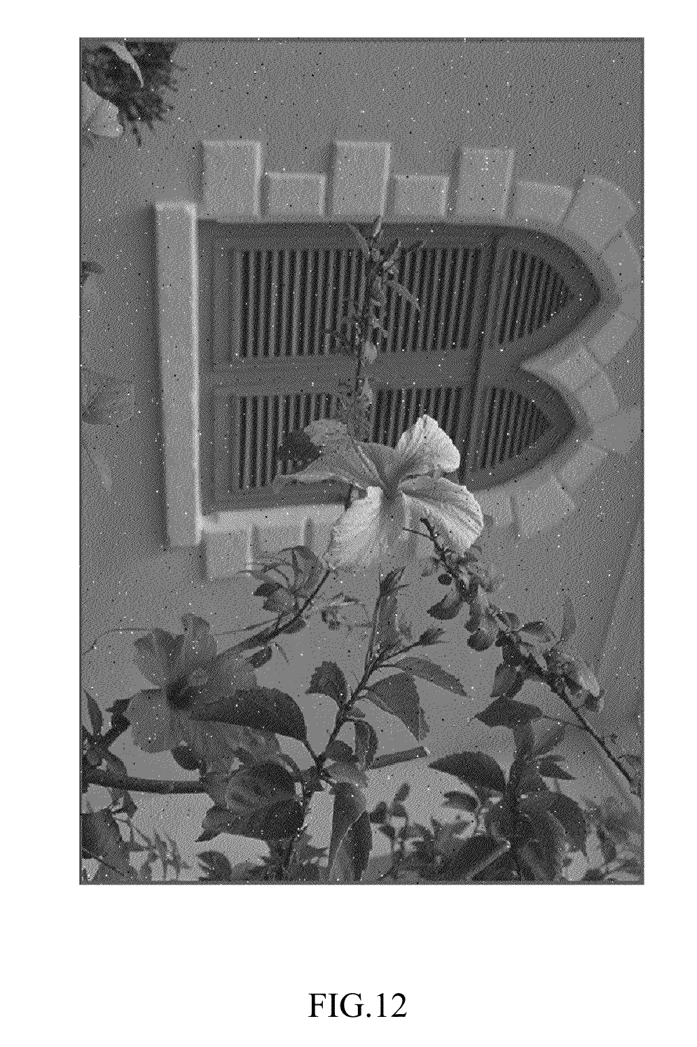

First, in this embodiment and other embodiments, the image processor 20 receives an input image from an image sensor or a storage module, the filter module 22 performs a high-pass filter processing on the input image, so as to obtain a filter image (step S100). Referring to FIG. 12 and FIG. 3, a schematic view of an input image according to an embodiment of the disclosure, and a schematic view of normal distribution of image content are shown respectively.

In the following embodiments, the input image is a gray-scale image. For example, the input image is a lightness layer in an HSL color space. However, the input image could be a red layer image, a blue layer image or a green layer image in an RGB color space, or various component layers in other color spaces. Moreover, for facilitating the detection of the dead pixel, 0.5% impulse noises are added in the input image in advance to simulate the dead pixels. Because the impulse noises of the dead pixels are generally much greater or much less than values of normal pixels (also referred to as normal points), the impulse noises form multiple white points or black points on the input image. Assume that multiple pixel values in the image are distributed normally the dead pixels are generally located at two sides of the normal distribution, as shown in FIG. 3.

The high-pass filter processing may be a Mexican hat filter Matrix. The Mexican hat filter Matrix has multiple weight values, and the weight value corresponding to a center position is larger than the weight values corresponding to positions surrounding and neighboring the center position. For example, in this embodiment and other embodiments, the weight value corresponding to the center position is a large positive value, and the weight values corresponding to positions surrounding and neighboring the center position are negative in value (first ring positions).

In order to further highlight the pixels having the unusual values in the input image, positive weight values are further provided for positions outside the positions surrounding and neighboring the center positions (second ring positions). Similarly, in this embodiment and other embodiments, the size and number of the rings used in the Mexican hat filter Matrix may vary. For example, the Mexican hat filter Matrix using a mask associated with the rings 7×7 in size and number could be good at highlighting the dead pixels.

In this embodiment, the sum of all weight values in the Mexican hat filter Matrix is equal to 1. Therefore, the Mexican hat filter Matrix does not affect a uniform image area, but highlights an area where a dead pixel locates (a dead pixel area for short).

An example of the content of the mask used by the Mexican hat filter Matrix is illustrated as follows, but the disclosure is not limited thereto.

$$[ \begin{matrix}- 1 & - 1 & - 1 & - 1 & - 1 & - 1 & - 1 \\ - 1 & 2 & 2 & 2 & 2 & 2 & - 1 \\ - 1 & 2 & - 5 & - 5 & - 5 & 2 & - 1 \\ - 1 & 2 & - 5 & 33 & - 5 & 2 & - 1 \\ - 1 & 2 & - 5 & - 5 & - 5 & 2 & - 1 \\ - 1 & 2 & 2 & 2 & 2 & 2 & - 1 \\ - 1 & - 1 & - 1 & - 1 & - 1 & - 1 & - 1\end{matrix} ]$$

The mask used by the Mexican hat filter Matrix being presented in 3-dimensional space is shown in FIG. 4. It is seen from FIG. 4 that, the weight value (“33”) at the center position is larger than the weight values for the first ring positions surrounding the center position (“−5”); in this embodiment and other embodiments, the center position is treated as a center, each ring with respect to the center (or the center position) is associated with the same weight value, and the weight values of the adjacent rings are different in sign.

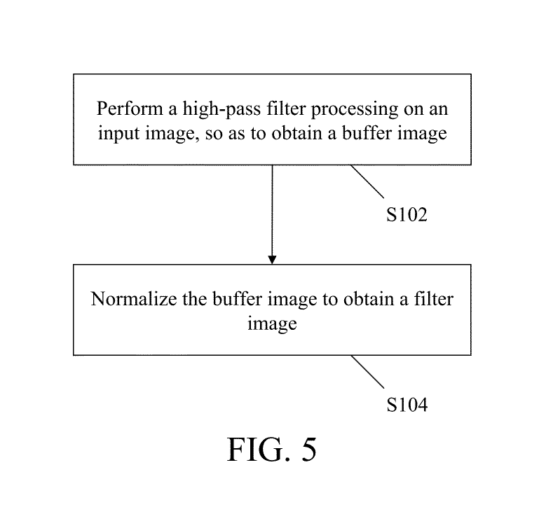

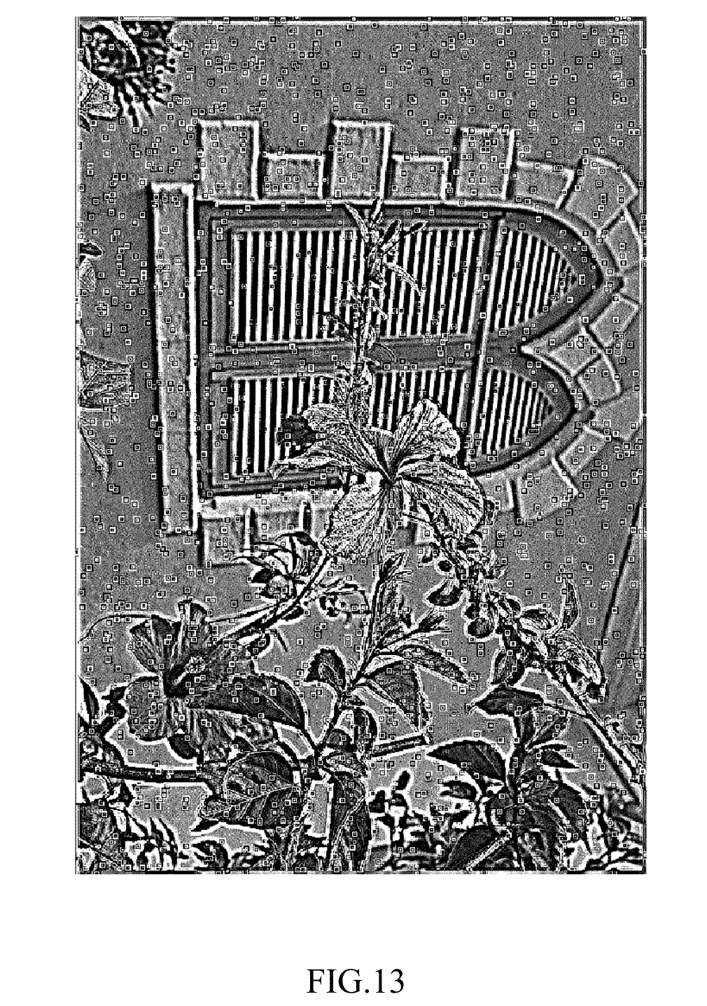

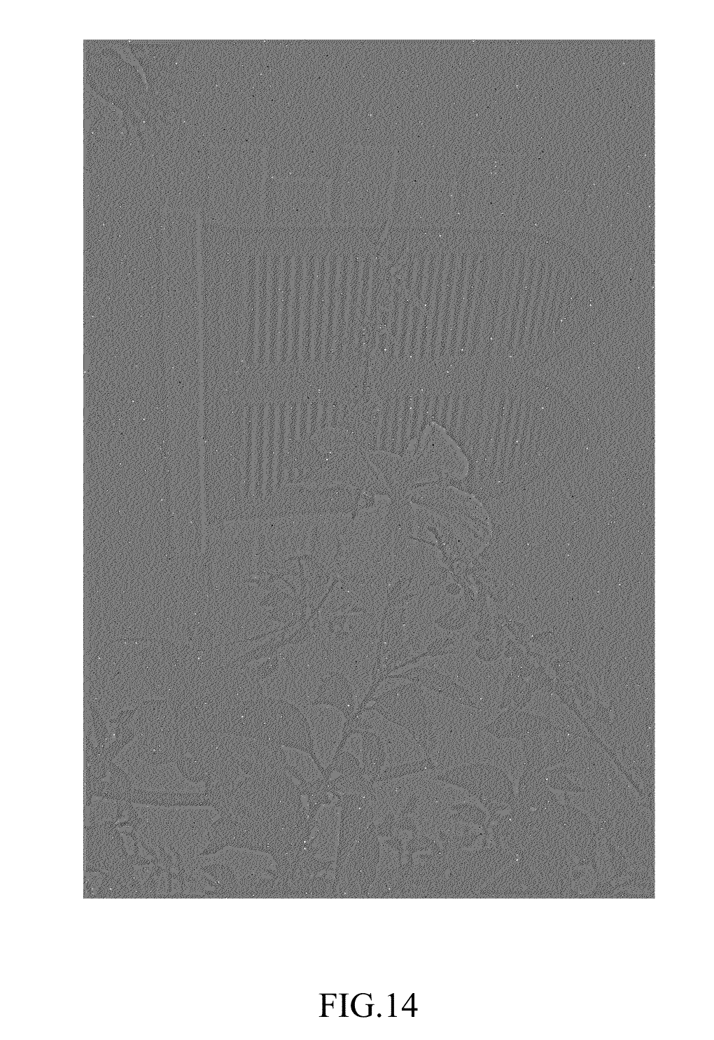

According to an embodiment of the disclosure, the image is normalized so that the pixel values are converged in a certain range, for facilitating the subsequent detection. Referring to FIG. 5, a schematic flow chart of step S100 according to an embodiment of the disclosure is shown. In this embodiment and other embodiments, the filter module 22 performs the high-pass filter processing on the input image, so as to obtain a buffer image (step S102), as shown in FIG. 13. The filter module 22 further normalizes the buffer image, so as to obtain the required filter image (step S104), where the step of normalizing the buffer image refers to calculating all pixel values in the buffer image to enable the pixel values to fall within a limited range, as shown in FIG. 14.

For example, a calculation formula used in the normalization is as follows, but the disclosure is not limited thereto. After being normalized by the formula, the pixel values in the filter image all fall within a range between 0 and 255.

$${I}_{ij}^{′} = \frac{{I}_{ij} - min \{ {I}_{m \times n} \}}{max \{ {I}_{m \times n} \} - min \{ {I}_{m \times n} \}} \times 255 ;$$

where I′ᵢⱼ is the pixel value of the normalized filter image, Iᵢⱼ is the pixel value of the original buffer image, min {I_{m×n}} is the minimum pixel value in the buffer image, and max {I_{m×n}} is the maximum pixel value in the buffer image.

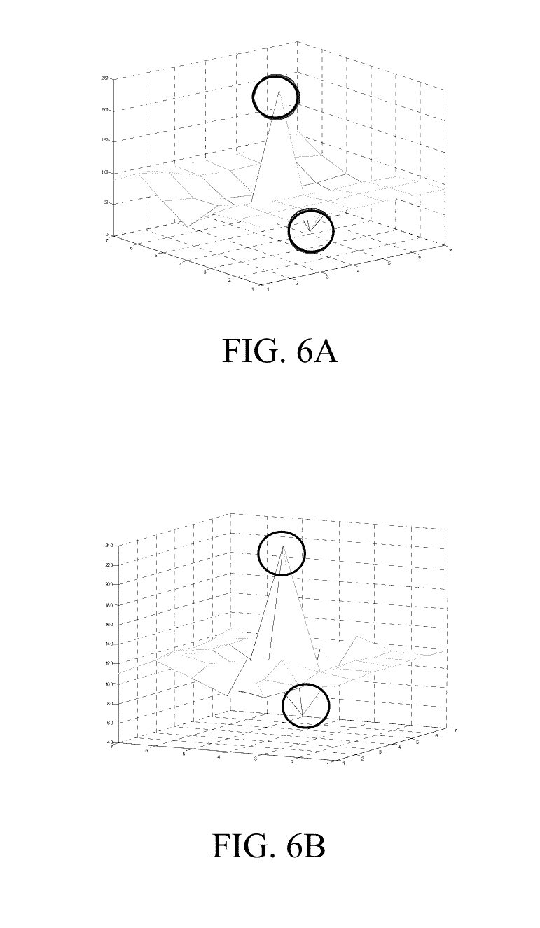

Referring to FIG. 6A and FIG. 6B, a schematic view of a dead pixel area according to an embodiment of the disclosure, and a schematic view of a dead pixel area after normalization are shown respectively. It is assumed that the size of the dead pixel area is the same as the size of the mask used in the Mexican hat filter Matrix, which is 7×7. It is seen from the drawings that the pixel value of the dead pixel (a circled peak portion), compared with the pixel value of other surrounding pixels, is particularly high or particularly low, and such discrepancy between the dead pixels and the normal pixels is more conspicuous after the process of the normal distribution.

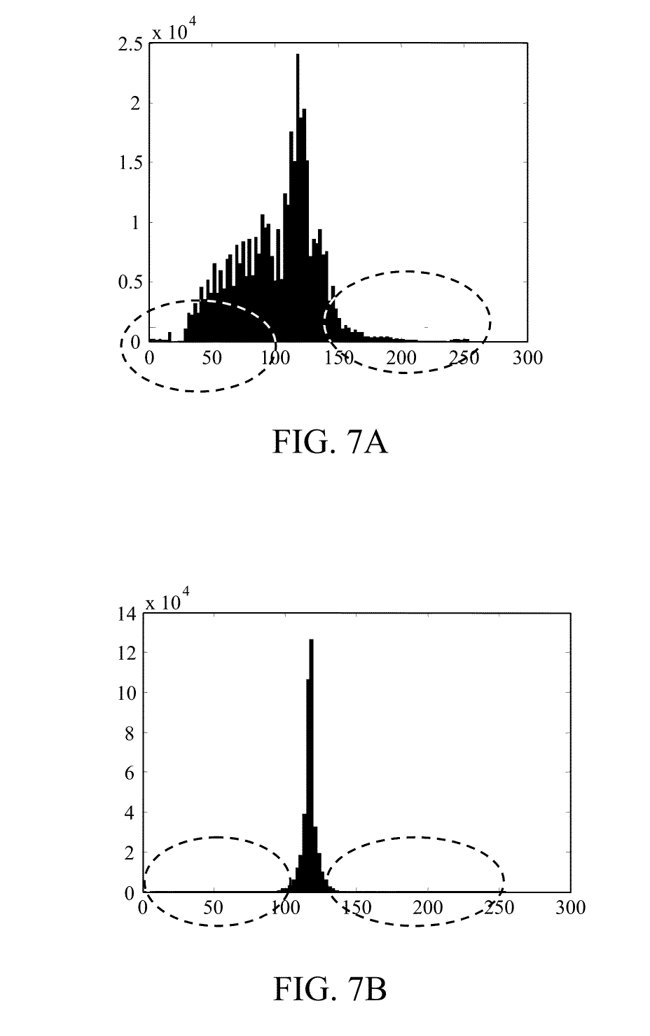

In brief, the high-pass filter processing could further highlight an uneven part in the area defined by the mask. Therefore, by processing the input image through the high-pass filter processing locations of the dead pixels could be further identified. Therefore, in the subsequent processing, the locations of the dead pixels could be determined by only having the area defined by the rings processed, thereby improving the accuracy of the dead pixel detection. Moreover, the high-pass filter processing is capable of correcting the distribution of low-frequency domain pixels in the input image, while maintaining the high-frequency domain pixels having the dead pixels at their original values. It is seen from FIG. 7A and FIG. 7B that, compared with the input image, noises in the filter image are quite concentrated, and are closer to the normal distribution.

After obtaining the filter image, the global calculation module 24 obtains a global mean value and a global standard difference according to the filter image (step S110). In this embodiment and other embodiments, the global calculation module 24 calculates a mean value of all pixel values in the filter image, so as to obtain the global mean value, and calculates a standard difference by using all the pixel values in the filter image, so as to obtain the global standard difference. In the disclosure, the standard difference is a statistics term and therefore the global standard difference mainly refers to the degree/extent of the distribution of all the pixel values in the filter image with the mean value located in the center.

According to an embodiment of the disclosure, the global calculation module 24, cooperating with a human face recognition procedure, provides a human face area in the filter image with a larger weight value, and calculates a weighted mean value of all the pixel values serving as the global mean value. Similarly, the global calculation module 24 is also capable of, cooperating with a procedure other than the image dead pixel detection method, calculating the global mean value or the global standard difference.

The global mean value and the global standard difference may be used to present the photographing scenario and the image content of the input image, and therefore could be used as references for the detection of the dead pixels. Since the photographing scenario in which the image is taken could be during the day, evening or night, using the global mean value and the global standard difference for identifying the presence of the dead pixels could reflect the photographing scenarios.

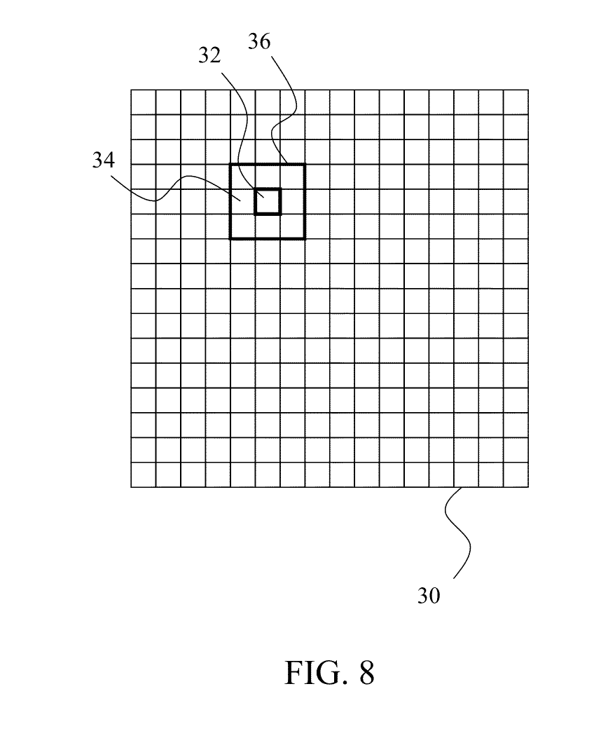

The local calculation module 26 selects a pixel from the filter image in sequence to serve as the to-be-detected pixel (step S120), and in this embodiment and other embodiments, cooperating with the determination module 28, executes the following step S130 to step S160 for each of the to-be-detected pixels. The local calculation module 26 first, according to the to-be-detected pixel, selects from the filter image multiple neighboring pixels neighboring the to-be-detected pixel, so as to form a local area. Referring to FIG. 8, a schematic view of a local area according to an embodiment of the disclosure is shown. After selecting a to-be-detected pixel 32 from a filter image 30, the to-be-detected pixel 32 and multiple neighboring pixels 34 surrounding and neighboring the to-be-detected pixel 32 are considered as the local area 36. In other words, in this embodiment and other embodiments, the local area 36 is a rectangular area formed by the neighboring pixels 34 surrounding the to-be-detected pixel 32 with the to-be-detected pixel 32 as the center of the defined local area 36. The local area 36 being 3×3 is taken as an example in the following; however, the disclosure is not limited thereto.

In addition, in this embodiment and other embodiments, the image processor 20 selects every pixel one by one in the filter image 30 to serve as the to-be-detected pixel 32. For saving operation time and improving operation performance, in this embodiment and other embodiments, it is also possible that one pixel is selected every several pixels to serve as the to-be-detected pixel 32; however, in doing do it is fully anticipated that the detection of the dead pixels may suffer.

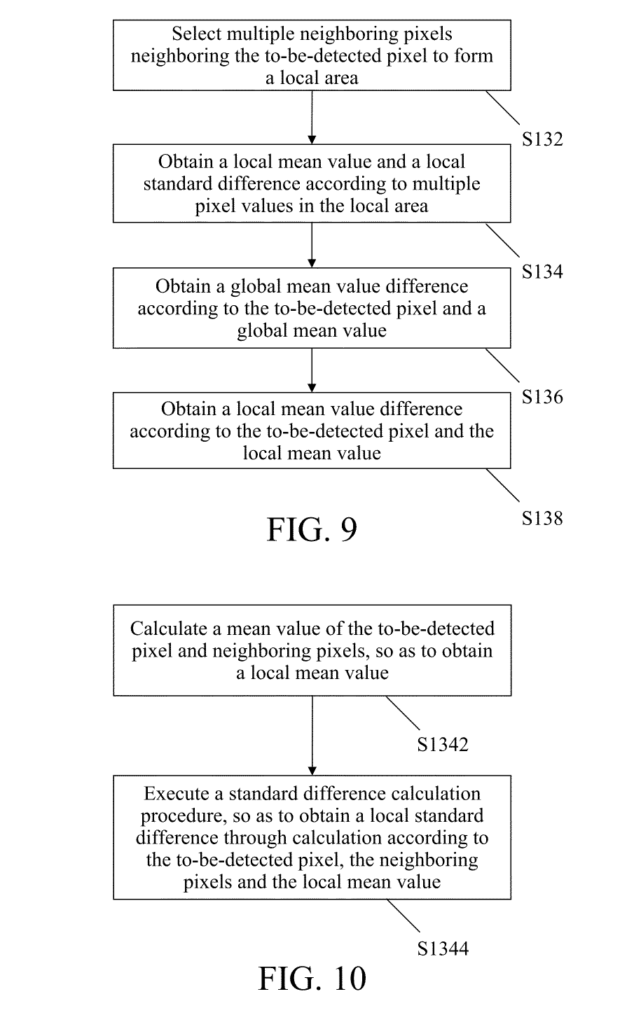

The local calculation module 26, according to the to-be-detected pixel 32 and the neighboring pixels 34, obtains a local mean value and a local standard difference of the current local area 36, a global mean value difference, and a local mean value difference (step S130). Referring to FIG. 9, a schematic flow chart of step S130 according to an embodiment of the disclosure is shown.

In this embodiment and other embodiments, the local calculation module 26 selects multiple neighboring pixels 34 neighboring the to-be-detected pixel 32 to form the local area 36 (step S132), and according to the multiple pixel values in the local area 36, obtains the local mean value and the local standard difference (step S134). The local calculation module 26 first calculates a mean value of the to-be-detected pixel 32 and neighboring pixels 34, so as to obtain the local mean value (step S1342), as shown in FIG. 10. In other words, a mean value of all pixel values in the local area 36 is calculated to serve as the local mean value.

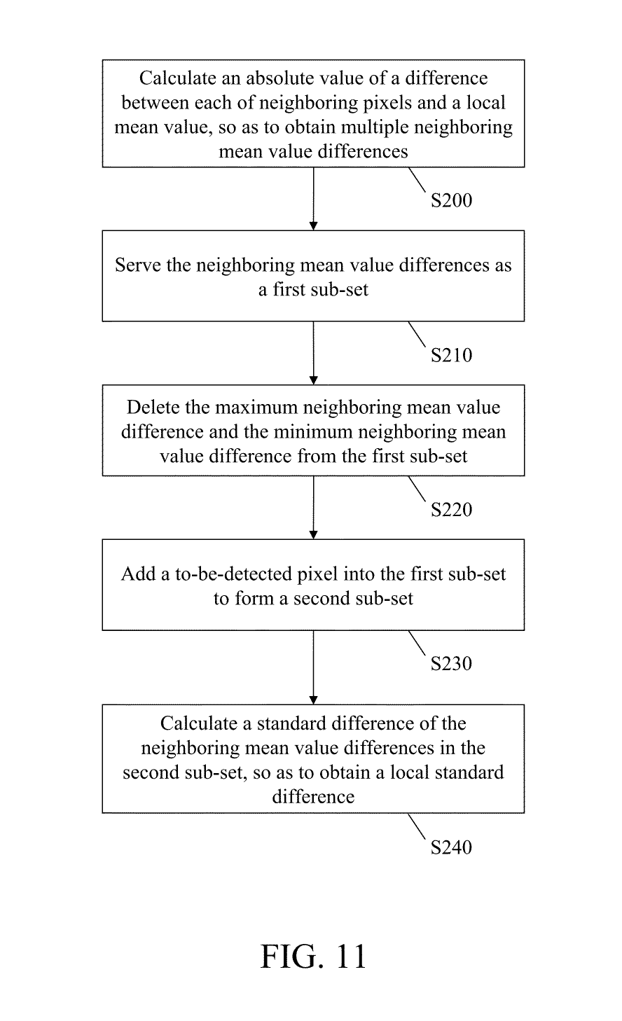

The local calculation module 26 also executes a standard difference calculation procedure, so as to obtain a local standard difference through calculation according to the to-be-detected pixel 32, the neighboring pixels 34 and the local mean value (step S1344). Referring to FIG. 11, a schematic flow chart of a standard difference calculation procedure according to an embodiment of the disclosure is shown.

First, absolute values of differences between each of the neighboring pixels 34 and the local mean value are calculated, and therefore multiple neighboring mean value differences could be obtained (step S200). In this embodiment and other embodiments, the local calculation module 26 subtracts the local mean value from the pixel values of the neighboring pixels 34 one by one, takes the absolute values to serve as the neighboring mean value differences, and utilizes all the neighboring mean value differences as a first sub-set (step S210). The local calculation module 26 sorts the neighboring mean value differences, deletes at least one maximum neighboring mean value difference and at least one minimum neighboring mean value difference from the first sub-set (step S220), and adds the pixel value of the to-be-detected pixel 32 into the first sub-set to form a second sub-set (step S230). The local calculation module 26 further calculates a standard difference of the neighboring mean value differences in the second sub-set, so as to obtain the local standard difference (step S240). The manner of removing the maximum value and the minimum value in the step S220 and step S230 avoids that inaccurate local standard difference due to two neighboring dead pixels that may lead to the erroneous detection of the dead pixels.

The image dead pixel detection method also takes the local mean value and the local standard difference as the reference for detecting the dead pixel, so as to determine whether the to-be-detected pixel 32 has an abnormal high value or low value. For example, in this embodiment and other embodiments, the to-be-detected pixel 32 is located in a local high brightness area such as sky, so even the pixel value of the to-be-detected pixel 32 is large, such to-be-detected pixel 32 is not necessarily a dead pixel. Similarly, the to-be-detected pixel 32 associated with the low pixel value does not necessarily deemed as the dead pixel, especially when the to-be-detected pixel 32 is located in a local low brightness area such as a night scene. Therefore, in this embodiment and other embodiments, the image dead pixel detection method determines whether the to-be-detected pixel 32 is the dead pixel with reference to the neighboring pixels 34.

The local calculation module 26 obtains the global mean value difference according to the pixel value of the to-be-detected pixel 32 and the global mean value (step S136), and obtains the local mean value difference according to the to-be-detected pixel 32 and the local mean value (step S138). In this embodiment and other embodiments, the global mean value difference is obtained by calculating an absolute value of a difference between the pixel value of the to-be-detected pixel 32 and the global mean value, and the local mean value difference is obtained by calculating an absolute value of a difference between the pixel value of the to-be-detected pixel 32 and the local mean value. However, in this embodiment and other embodiments, the step S136 is also performed by the global calculation module 24 to calculate the global mean value difference.

After obtaining the global mean value difference and the local mean value difference, the determination module 28 determines whether the global mean value difference and the global standard difference satisfy a first condition, and whether the local mean value difference and the local standard difference satisfy a second condition (step S140).

It is determined that, when the global mean value difference and the global standard difference corresponding to any to-be-detected pixel 32 satisfy the first condition, and the local mean value difference and the local standard difference corresponding to the to-be-detected pixel 32 satisfy the second condition, the to-be-detected pixel 32 is considered as a dead pixel (step S150). In other words, in this embodiment and other embodiments, the to-be-detected pixel 32 satisfying the first condition and the second condition is considered as the dead pixel. In contrast, when the global mean value difference and the global standard difference corresponding to any to-be-detected pixel 32 do not satisfy the first condition, or the local mean value difference and the local standard difference corresponding to the to-be-detected pixel 32 do not satisfy the second condition, the to-be-detected pixel 32 is regarded as a normal pixel (step S160).

According to an embodiment of the disclosure, in this embodiment and other embodiments, the first condition is that a difference of the global mean value difference and the global standard difference is greater than a global threshold; and the second condition is that a difference of the local mean value difference and the local standard difference is greater than a local threshold. Therefore, when a difference of the global mean value difference and the global standard difference corresponding to the to-be-detected pixel 32 is greater than the global threshold, and a difference of the local mean value difference and the local standard difference corresponding to the to-be-detected pixel 32 is greater than the local threshold, the to-be-detected pixel 32 is considered as a dead pixel. In contrast, when the difference of the global mean value difference and the global standard difference is less than or equal to the global threshold, or the difference of the local mean value difference and the local standard difference is less than or equal to the local threshold, the to-be-detected pixel 32 is considered as a normal pixel.

As shown in FIG. 3, the dead pixels are generally distributed at two sides of the normal distribution. By taking a mean value μ as a center, pixels having a difference between the pixel value and the mean value μ less than one standard difference (σ) are around 68.2% of all pixels, pixels having a difference between the pixel value and the mean value μ less than two standard differences (2σ) are around 95.4% of all pixels, and pixels having a difference between the pixel value and the mean value μ less than three standard differences (3σ) are about 99.6% of all pixels. Therefore, in this embodiment and other embodiments, the global threshold or local threshold could be set as a multiple of the global standard difference or local standard difference. For example, in this embodiment and other embodiments, the global threshold is set as 3.7 times of the global standard difference, and the local threshold is set as 2 times of the local standard difference. Because the maximum and the minimum neighboring mean value differences are deleted before the local standard difference is calculated, in this embodiment and other embodiments, the local threshold could be lowered. In addition, it is also possible to set the global threshold and the local threshold according to the concentration degree of the dead pixels after the high-pass filter processing.

After determining that the current to-be-detected pixel 32 is the dead pixel or the normal pixel, in this embodiment and other embodiments, the image processor 20 determines whether the whole filter image 30 has been processed (step S190). If the whole filter image 30 has been processed, the detection ends; otherwise, the procedure proceeds to the step S120 to select the next to-be-detected pixel 32 and continue the detection. After determining the location of the dead pixel by using the image dead pixel detection method, in this embodiment and other embodiments, dead pixel compensation is performed for the identified dead pixels using the surrounding normal pixels.

When the input image is 768×512 in resolution, and 0.5% impulse noises are added in advance, 1963 dead pixels have been identified on basis of the above-mentioned method. In the 393216 pixels of the input image, 86 pixels are determined incorrectly, where 60 dead pixels are determined as the normal pixels, and 26 normal pixels are determined as the dead pixels. Therefore, the detection rate of the dead pixel reaches 99.9%.

Generally, the dead pixel should be different compared with the neighboring normal pixels, and therefore, in this embodiment and other embodiments, whether the to-be-detected pixel is a dead pixel is determined according to the local mean value and the local standard difference. However, in a local area, the abnormal pixel values of the dead pixel affect the mean value of the pixels within the entire local area. For example, a stuck at high dead pixels lead to increased mean value, and stuck at low dead pixels result in the reduced mean value. Therefore, using the global mean value and the global standard difference as the basis for the detection of the dead pixel may somehow help eliminate the factors of those pixels with abnormally high/low pixel values, improving the accuracy of the determination of the dead pixels.

Further, parameters such as the global mean value, the global standard difference, the local mean value and the local standard difference all reflect the image content (scenario) of the input image. In this embodiment and other embodiments, the global threshold and the local threshold dynamically change according to the varying global standard difference or the local standard difference, and therefore, the image dead pixel detection method could dynamically adjust, according to the content of the input image, the parameters for the detection of the dead pixels. Furthermore, because the global threshold and the local threshold are adjusted dynamically according to different image contents or photographing scenarios, manual thresholds setting may become unnecessary.

Determining whether relevant parameters of the to-be-detected pixel satisfy the global first condition and the local second condition is applicable to various scenarios. The relevant parameters are calculated statistically rather than remain constant, so the relevant parameters are obtained dynamically according to the different scenarios. For example, when the method is applied in a digital camera, the dead pixel detection is performed automatically for every picture photographed, before the corresponding compensation could be performed. No matter at day, evening or night, the global mean value, global standard difference, local mean value and local standard difference serving as the determination references are adjusted automatically according to the photographing scenario.

Further, the dead pixel detection method may have better image adaptability, when calculating in real time the global and local parameters serving as the determination references according to the image content, which could also help detect the unexpected dead pixels. Because the global mean value and the global standard difference are used as references when it comes to detecting the dead pixels, it may become less likely that the image edges or detailed structures are considered as the dead pixels.

Therefore, for an astronomical image requiring long exposure time, the dead pixel detection and compensation are performed on the image after the image is photographed, which does not increase the required time for photographing. For a medical image, the dead pixels are determined more accurately while the high-frequency domain pixels in an original image could remain intact, thereby ensuring the quality of the image.

To sum up, in the image processor and the image dead pixel detection method in the disclosure, the high-pass filter processing is performed on the input image, and the global mean value, global standard difference, local mean value and local standard difference are used as references for detecting/determining the dead pixels, so that the disclosure is capable of detecting the dead pixel more accurately, and is applicable to input images with different contents or photographing scenarios.

What is claimed is:

1. An image dead pixel detection method, for detecting at least one dead pixel in an input image, comprising:
performing a high-pass filter processing on the input image to obtain a filter image;
obtaining a global mean value and a global standard difference according to the filter image;
selecting a to-be-detected pixel in the filter image;
obtaining a local mean value, a local standard difference, a global mean value difference and a local mean value difference according to the to-be-detected pixel and multiple neighboring pixels; and
determining whether the global mean value difference and the global standard difference corresponding to the to-be-detected pixel satisfy a first condition, and whether the local mean value difference and the local standard difference corresponding to the to-be-detected pixel satisfy a second condition, before considering the to-be-detected pixel as the dead pixel.

2. The image dead pixel detection method according to claim 1, wherein the step of performing the high-pass filter processing on the input image to obtain the filter image comprises:
performing the high-pass filter processing on the input image to obtain a buffer image; and
normalizing the buffer image to obtain the filter image.

3. The image dead pixel detection method according to claim 2, wherein the step of normalizing the buffer image to obtain the filter image calculates multiple pixel values in the buffer image to enable the multiple pixel values to fall within a limited range.

4. The image dead pixel detection method according to claim 1, wherein the step of obtaining the global mean value and the global standard difference according to the filter image comprises:
calculating a mean value of multiple pixel values of the filter image, so as to obtain the global mean value; and
calculating a standard difference of the multiple pixel values of the filter image, so as to obtain the global standard difference.

5. The image dead pixel detection method according to claim 1, wherein the step of selecting the to-be-detected pixel in the filter image selects each of pixels of the filter image one by one to serve as the to-be-detected pixel, or selects one pixel among a predetermined amount of the pixels to serve as the to-be-detected pixel.

6. The image dead pixel detection method according to claim 1, wherein the step of obtaining the local mean value, the local standard difference, the global mean value difference and the local mean value difference according to the to-be-detected pixel and the neighboring pixels comprises:
selecting the neighboring pixels neighboring the to-be-detected pixel to form a local area;
obtaining the local mean value and the local standard difference according to multiple pixel values in the local area;
obtaining the global mean value difference according to the to-be-detected pixel and the global mean value; and
obtaining the local mean value difference according to the to-be-detected pixel and the local mean value.

7. The image dead pixel detection method according to claim 6, wherein the local area is a rectangular area formed by the neighboring pixels surrounding the to-be-detected pixel with the to-be-detected pixel as a center.

8. The image dead pixel detection method according to claim 6, wherein the step of obtaining the local mean value and the local standard difference according to the pixel values in the local area comprises:
calculating a mean value of the to-be-detected pixel and the neighboring pixels, so as to obtain the local mean value; and
executing a standard difference calculation procedure, so as to obtain the local standard difference according to the to-be-detected pixel, the neighboring pixels and the local mean value.

9. The image dead pixel detection method according to claim 8, wherein the standard difference calculation procedure comprises:
calculating an absolute value of a difference between each of the neighboring pixels and the local mean value, so as to obtain multiple neighboring mean value differences;
considering the neighboring mean value differences as a first sub-set;
deleting at least one maximum neighboring mean value difference and at least one minimum neighboring mean value difference in the first sub-set;
adding the to-be-detected pixel to the first sub-set, so as to form a second sub-set; and
calculating a standard difference of the neighboring mean value differences in the second sub-set, so as to obtain the local standard difference.

10. The image dead pixel detection method according to claim 6, wherein the step of obtaining the global mean value difference according to the to-be-detected pixel and the global mean value comprises:
calculating an absolute value of a difference of a pixel value of the to-be-detected pixel and the global mean value, so as to obtain the global mean value difference;
wherein the step of obtaining the local mean value difference according to the to-be-detected pixel and the local mean value comprises:
calculating an absolute value of a difference of the pixel value of the to-be-detected pixel and the local mean value, so as to obtain the local mean value difference.

11. The image dead pixel detection method according to claim 1, wherein the first condition is that a difference of the global mean value difference and the global standard difference is greater than a global threshold.

12. The image dead pixel detection method according to claim 1, wherein the second condition is that a difference of the local mean value difference and the local standard difference is greater than a local threshold.

13. The image dead pixel detection method according to claim 1, further comprising:
determining whether the global mean value difference and the global standard difference corresponding to the to-be-detected pixel fail to satisfy the first condition, or the local mean value difference and the local standard difference corresponding to the to-be-detected pixel fail to satisfy the second condition, before considering the to-be-detected pixel as a normal pixel.

14. The image dead pixel detection method according to claim 1, wherein the input image is a gray-scale image, a red layer image, a blue layer image or a green layer image.

15. An image processor, for detecting at least one dead pixel in an input image, the image processor comprising:
a filter module, for performing a high-pass filter processing on the input image to obtain a filter image;
a global calculation module, for obtaining a global mean value and a global standard difference according to the filter image;
a local calculation module, for selecting a to-be-detected pixel from the filter image, and obtaining a local mean value, a local standard difference, a global mean value difference and a local mean value difference according to the to-be-detected pixel and multiple neighboring pixels; and
a determination module, for determining whether the global mean value difference and the global standard difference corresponding to the to-be-detected pixel satisfy a first condition, and whether the local mean value difference and the local standard difference corresponding to the to-be-detected pixel satisfy a second condition, before considering the to-be-detected pixel as the dead pixel.

16. The image processor according to claim 15, wherein the filter module performs the high-pass filter processing on the input image to obtain a buffer image, and normalizes the buffer image to obtain the filter image.

17. The image processor according to claim 16, wherein the normalizing the buffer image is by calculating multiple pixel values in the buffer image to enable the multiple pixel values to fall within a limited range.

18. The image processor according to claim 15, wherein the global calculation module calculates a mean value of multiple pixel values in the filter image to obtain the global mean value, and calculates a standard difference of the pixel values in the filter image, so as to obtain the global standard difference.

19. The image processor according to claim 15, wherein the local calculation module selecting the to-be-detected pixel from the filter image selects each of pixels one by one from the filter image to serve as the to-be-detected pixel, or selects one of the pixels among a predetermined amount of the pixels to serve as the to-be-detected pixel.

20. The image processor according to claim 15, wherein the local calculation module selects the neighboring pixels neighboring the to-be-detected pixel to from a local area, obtains the local mean value and the local standard difference according to multiple pixel values in the local area, obtains the global mean value difference according to the to-be-detected pixel and the global mean value, and obtains the local mean value difference according to the to-be-detected pixel and the local mean value.

21. The image processor according to claim 20, wherein the local area is a rectangular area formed by the neighboring pixels surrounding the to-be-detected pixel with the to-be-detected pixel as a center.

22. The image processor according to claim 20, wherein the local calculation module calculates a mean value of the to-be-detected pixel and the neighboring pixels to obtain the local mean value, and executes a standard difference calculation procedure to obtain the local standard difference according to the to-be-detected pixel, the neighboring pixels and the local mean value.

23. The image processor according to claim 22, wherein the standard difference calculation procedure comprises:
calculating an absolute value of a difference between each of the neighboring pixels and the local mean value, so as to obtain multiple neighboring mean value differences;
considering the neighboring mean value differences as a first sub-set;
deleting at least one maximum neighboring mean value difference and at least one minimum neighboring mean value difference in the first sub-set, and adding the to-be-detected pixel to the first sub-set, so as to form a second sub-set; and
calculating a standard difference of the neighboring mean value differences in the second sub-set, so as to obtain the local standard difference.

24. The image processor according to claim 20, wherein the local calculation module calculates an absolute value of a difference between a pixel value of the to-be-detected pixel and the global mean value, so as to obtain the global mean value difference, and calculates an absolute value of a difference between the pixel value of the to-be-detected pixel and the local mean value, so as to obtain the local mean value difference.

25. The image processor according to claim 15, wherein the first condition is that a difference of the global mean value difference and the global standard difference is greater than a global threshold.

26. The image processor according to claim 15, wherein the second condition is that a difference of the local mean value difference and the local standard difference is greater than a local threshold.

27. The image processor according to claim 15, wherein the determination module determines whether the global mean value difference and the global standard difference corresponding to the to-be-detected pixel fails to satisfy the first condition, or whether the local mean value difference and the local standard difference corresponding to the to-be-detected pixel fail to satisfy the second condition, before considering the to-be-detected pixel as a normal pixel.

28. The image processor according to claim 15, wherein the input image is a gray-scale image, a red layer image, a blue layer image or a green layer image.
